(19) United States
(12) Patent Application Publication
(10) Pub. No.: US 2023/0062979 A1
(43) Pub. Date: Mar. 2, 2023

(54) SYSTEM FOR A WINDOW COVERING

(71) Applicant: Rollease Acmeda, Inc., Stamford, CT (US)

(72) Inventor: Aidan Arthur Schofield, Airport West VIC (AU)

(73) Assignee: Rollease Acmeda, Inc., Stamford, CT (US)

(21) Appl. No.: 17/882,527

(22) Filed: Aug. 5, 2022

(30) Foreign Application Priority Data
Aug. 25, 2021 (AU) 2021902726

(51) Int. Cl. E06B 9/44

(52) U.S. Cl. CPC E06B 9/44

(57) ABSTRACT

Disclosed herein is a system for a window cowering. The system may comprise an elongate tube around which the window covering is able to be wound, first and second mounting members each comprising first and second spaced projections that extend from an internal wall of the elongate tube, and a reducer mounted to the first end of the elongate tube that includes first and second recesses that are configured to receive the first and second mounting members respectively to enable the reducer to be fastened to the first end of the elongate tube.

### TECHNICAL FIELD

Disclosed herein is system for a window covering (e.g. a roller blind). The system includes an elongate tube around which the window covering is able to be wound, first and second mounting members that extend from an internal wall of the tube, and a reducer mounted to the tube that is configured to connect the roller blind to a support structure to support the system roller blind.

### BACKGROUND ART

Roller blinds may include a tube about which a length of material is wrapped. The tube is typically rotated to extend and retract the length of material to, for example, cover and expose a window. The tube, which is typically formed as an aluminium extrusion, may be supported at either end via a reducer that is received within an end of the elongate tube and connects the tube to a support structure for the roller blind.

The reducer, which is typically formed from a plastic material, may be mounted to either end of the tube. This may be achieved by pre-drilling holes in the tube and inserting pop rivets into these holes. Pop rivets require extensive time and a skilled labourer to assemble, which increases assembly costs. Also, once assembled, pop rivets can damage (e.g. leave marks on) the material rolled around the elongate tube. This may be because the pop rivets protrude and catch onto the material. Countersinking pop rivets so that they do not protrude is a difficult and time-consuming process, leading to further expense. When no rivets or other securing method is used the reducer may become disconnected from the tube, which can cause the hardware to disconnect in use. When the hardware becomes disconnected, the blind may be inoperable until an installer (e.g. tradesperson) is called out on a service call to the end user to fix the system. Alternatively, when the hardware becomes partially disconnected, components of the system may make an unacceptable noise during operation, and therefore still require a service call to rectify the issue.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

Disclosed herein is a system for a window covering. The system may comprise an elongate tube around which the window covering is able to be wound, the elongate tube being configured to rotate and thereby move the window covering between a retracted position and an extended position. The system may comprise first and second mounting members, the first and second mounting member each comprising first and second spaced projections that extend from an internal wall of the elongate tube. The system may comprise a reducer mounted to the first end of the elongate tube. The reducer may comprise a skirt that is configured to be received within the first end of the elongate tube, the skirt comprising first and second recesses formed therein that are configured to receive the first and second mounting members respectively to enable the reducer to be fastened to the first end of the elongate tube. A benefit of the disclosed system may be removing or reducing the need for potential service calls associated with prior art systems, which saves the user and/or installer time and money.

In some forms, the reducer may comprise a reducing portion that extends from a first end that is connected to the skirt to a second end that is spaced from the first end of the elongate tube, the first end of the second portion having a larger diameter than the second end of the reducing portion, the reducing portion being configured to connect the system to a support structure to support the system in use.

In some forms, the reducing portion comprises first and second mourning apertures formed therethrough that are substantially aligned with the first and second recesses of the skirt respectively.

In some forms, the system further comprises first and second fasteners configured to mount the reducer to the tube, the first fastener extending through the first mounting aperture of the reducing portion, into the first recess of the skirt, and being received between the first and second spaced projections of the first mounting member; and the second fastener extending through the second mounting aperture of the reducing portion, into the second recess of the skirt, and being received between the first and second spaced projections of the second mounting member.

In some forms, the first and second mounting members are disposed on opposite sides of the internal wall of the elongate tube.

In some forms, the system may comprise: an idler mounted to the reducer, the idler comprising; an elongate housing that extends between first and second ends and defines a cavity therein; a face disposed at the first end of the housing, the face having an aperture formed therethrough; a shaft extending from the cavity through the aperture and away from the face, the shaft being configured to connect the system to a support structure and enable the elongate tube to rotate with respect to the support structure in use to move the window covering between the retracted and extended positions.

In some forms, the skirt and reducing portion of the reducer together define a mounting aperture that extends through the reducer and along a longitudinal axis of the reducer.

In sonic forms, the reducer comprises an internal wall that extends from second end of the reducer and surrounds the mounting aperture, the internal wall comprising a plurality of spaced slots formed therein that extend substantially parallel to longitudinal axis of the reducer.

In some forms, the housing of the idler comprises a plurality of mounting structures that extend along an outer surface of the housing, wherein each of the plurality of mounting structures is configured to be received by a respective slot of the reducer to mount the idler to the reducer.

In some forms, the internal wall of the reducer comprises an annular ledge disposed at a first end of the internal wall and within the housing, and each of the plurality of mounting structures of the idler comprises a hook, wherein the hook of each mounting structure and annular ledge cooperate to inhibit movement of the idler with respect to the reducer away from the first end of the tube to mount the idler to the reducer.

In some forms, the mounting structures of the idler are tapered to inhibit movement of the idler with respect to the reducer towards the second end of the tribe to mount the idler to the reducer.

### BRIEF DESCRIPTION OF THE DRAWINGS

Various embodiments/aspects of the disclosure will now be described with reference to the following figures.

FIG. 1 shows an exploded view of several components of the roller blind system in accordance with the present disclosure;

FIG. 2 shows a cross sectional view through an end of the tube of the system shown in FIG. 1;

FIG. 3 shows a perspective view of an end of the tube of the system shown in FIG. 1 from the top (FIG. 3a) and the bottom (FIG. 3b);

FIGS. 4 shows a perspective view of the reducer of the system shown in FIG. 1;

FIG. 5 shows a perspective view of an end of the roller blind system shown in FIG. 1;

FIG. 6 shows a side view of the roller blind system shown in FIG. 1;

FIG. 7 shows a cross sectional view through the roller blind system shown in FIG. 1; and

FIG. 8 shows a perspective view of another embodiment of the roller blind system in accordance with the present disclosure.

### DETAILED DESCRIPTION

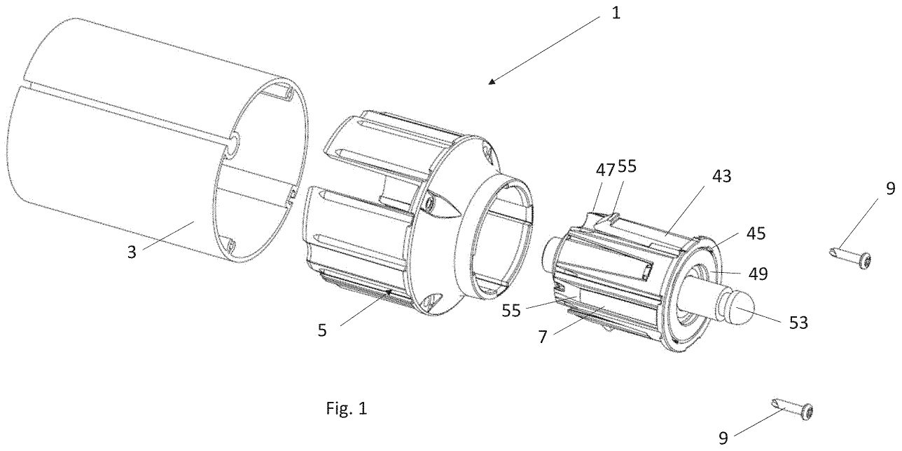

Disclosed herein is a system for a window covering e.g. a roller blind). FIG. 1 shows an exploded view of several components of the roller blind system 1. The system 1 includes an elongated tube, in the form of roller tube 3, around which a window covering is able to be wound (e.g. a length of material). The window covering is not shown. As will be evident to the skilled addressee, FIG. 1 provides a view of one end of the roller tube 3. In the detailed embodiment, the roller tube 3 is an aluminium extrusion, approximately 80 mm in diameter. The roller tube 3 is configured to rotate in use and thereby move the window covering between a retracted position and an extended position. In other words, rotation of the roller tube causes the length of material to unwind to an extended position (e.g. to cover a window) and to wind over the roller tube 3 to a retracted position (e.g. to uncover a window).

The system 1 also includes a reducer 5 that is connected to the roller tube 3. In the detailed embodiment, the reducer 5 is an injection moulded plastic structure with an outer diameter that fits the internal profile of the roller tube 3. The system 1 also includes an idler 7 that is connected to the reducer 5. The idler 7 is a multi-part assembly, and includes an injection moulded plastic housing, a machined stainless-steel shaft and internal components (e.g. internal roller bearings, compression spring and circiip). These internal components will not be described in further detail. The outer diameter of the idler 7 corresponds with the inner diameter of the reducer 5 such that it is able to be partially received therein. The idler 7 includes snap connection features that are configured to engage corresponding internal features of the reducer 5. The system 1 also includes fasteners 9 that are configured to mount the plastic reducer 5 to the aluminium roller tube 3.

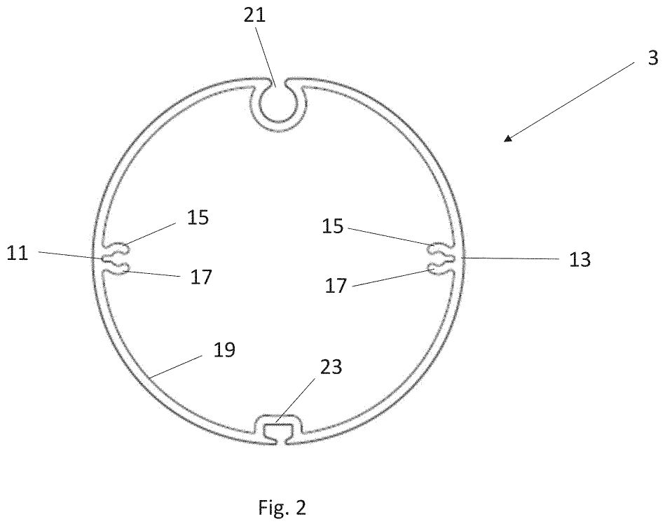

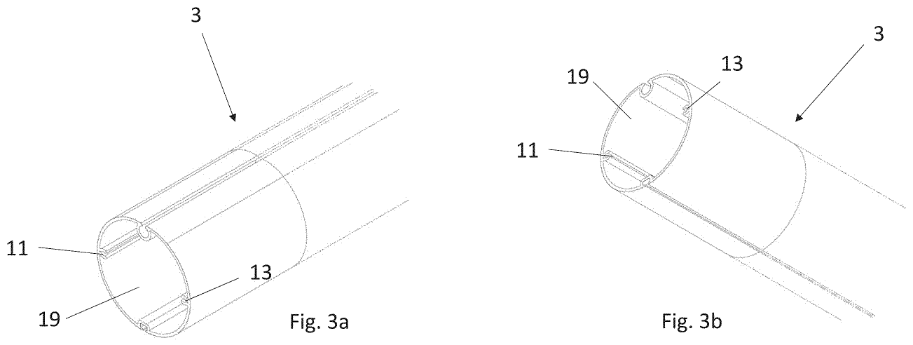

The roller tube 3 will now be described in further detail with respect to FIGS. 2 and 3. FIG. 2 provides a cross sectional view through an end of the roller tube 3. FIGS. 3a and 3b provide a perspective view of an end of the roller tube 3 from the top (FIG. 3a) and the bottom (FIG. 3b). Dashed lines are shown in FIGS. 3a and 3b to represent an undefined length (i.e. the roller tube 3 may be of any length to, for example, suit a width of a window). In the detailed embodiment, the roller tube 3 is an aluminium extrusion. Therefore, the structure of the roller tube 3 is the same along the length of the tube. As will be evident to the skilled addressee, in another embodiment the roller tube 3 may have different structures at either end, or may have a different structure between the ends (e.g. no mounting structures, as will be described in further detail below).

The roller tube 3 includes first 11 and second 13 mounting members. The first 11 and second 13 mounting members each include first 15 and second 17 spaced projections that extend from an internal wall 19 of the roller tube 3. The first 15 and second 17 spaced projections form a mounting aperture therebetween. that is configured to receive a self-tapping screw to fix the roller tube 3 to the reducer 5. The first 15 and second 17 spaced projections are curved such that the mounting aperture formed between the projections is substantially circular in cross-section. The distal ends of the first 15 and second 17 projections are spaced from one another. In the detailed embodiment, the first mounting member 11 is disposed on the opposite side of the roller tube 3 from the second mounting member 13. This relatively even spacing about the internal wall 19 of the roller tube 3 enables a secure connection between the reducer 5 and the roller tube 3.

The roller tube 3 also includes two further structures 21, 23 that extend away from the internal wall 19 of the roller tube 3. The purpose of both the round structure 21 and the square structure 23 is to allow a length of fabric to be attached to the tube 3. Structures 21 or 23 are welded to the fabric, then inserted into the tube 3 to provide a secure connection between the tube & the fabric. In the detailed embodiment, the internal features of the tube 3 are spaced 90° to maintain a consistent stiffness as the tube rotates. As will be evident to the skilled addressee, alternative arrangements are envisaged (e.g. six internal structures, which may include more than two mounting members, may have a 60° spacing therebetween.

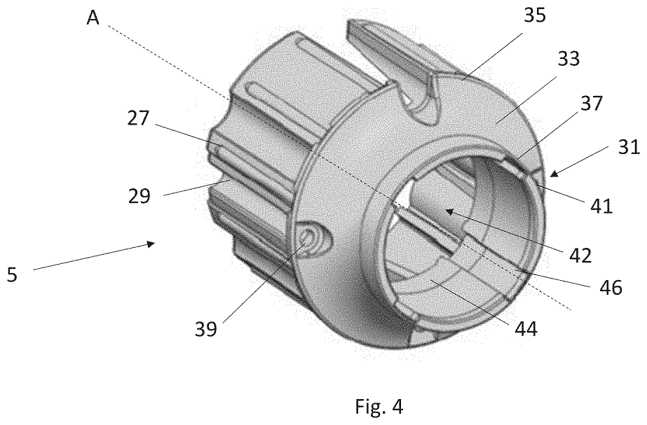

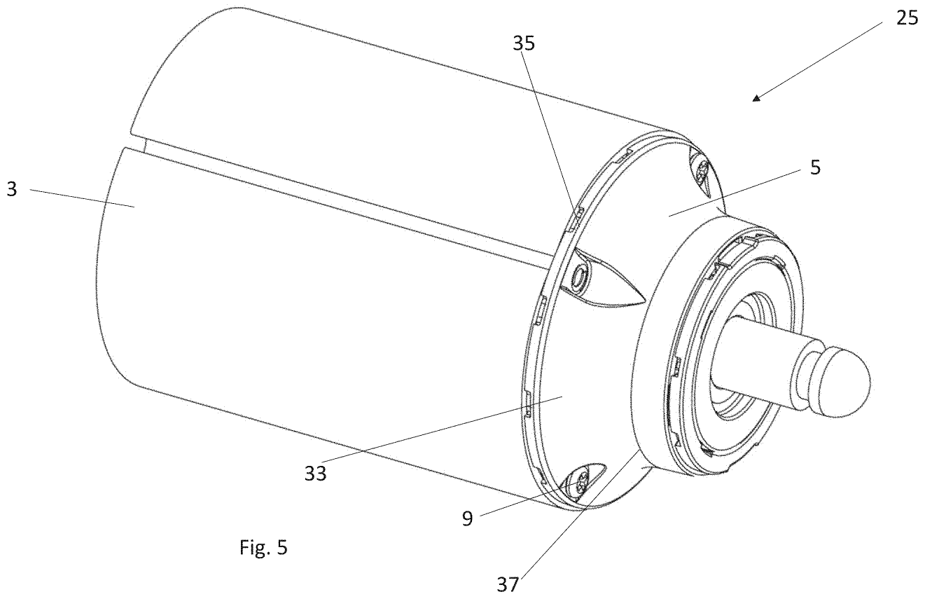

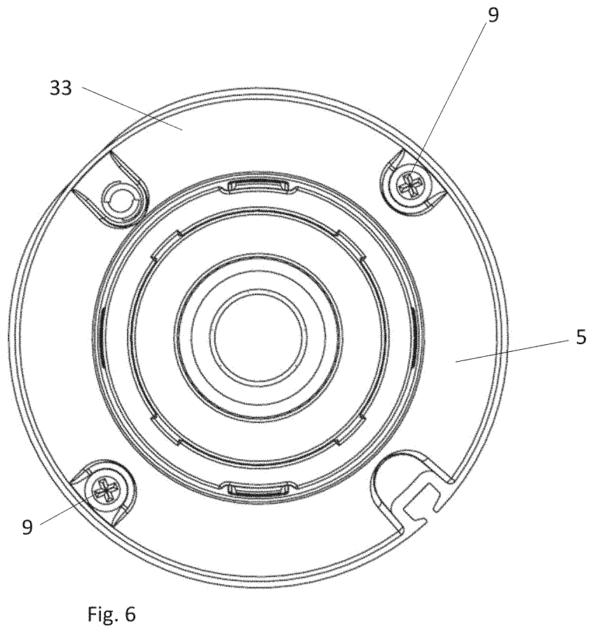

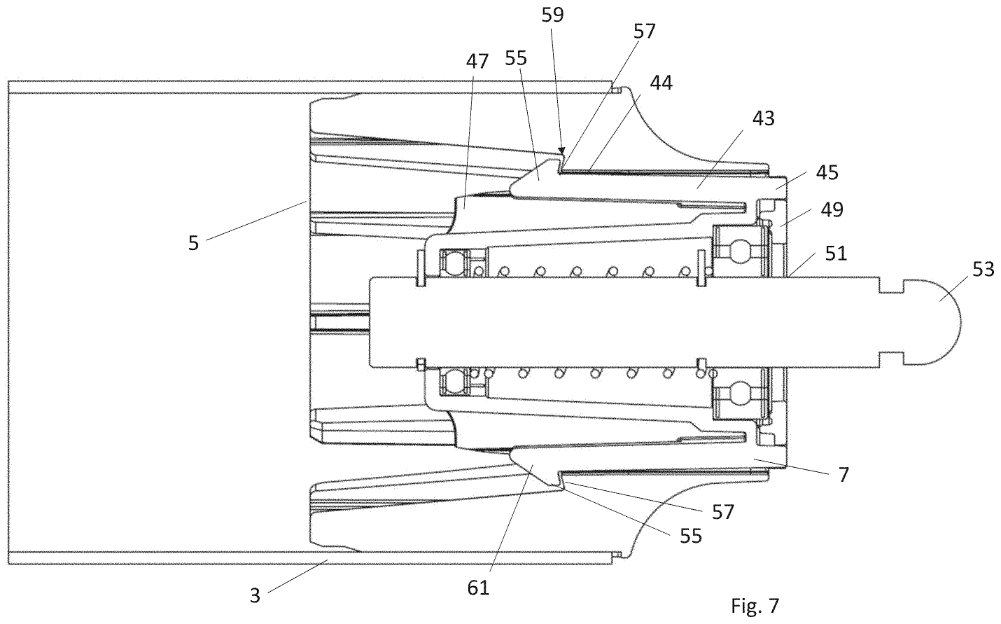

The reducer 5 and idler 7 will now be described in further detail with respect to FIG. 1 and FIGS. 4-7. FIG. 4 provides a perspective view of the reducer 5. FIG. 5 provides a perspective view of an end of the roller blind system shown in FIG. 1. FIG. 6 provides a side view of the roller system shown in FIG. 1. FIG. 7 provides a cross sectional view through the roller blind system shown in FIG. 1.

As is shown in FIG. 5, the reducer 5 is mounted to the first end 25 of the roller tube 3, As is shown in FIG. 4, the reducer 5 includes a skirt 27 that is configured to be received within the first 25 end of the elongate roller tube 3, The skirt 27 includes first 29 and second 31 recesses formed therein that are configured to receive the first and second mounting members 9 respectively to enable the reducer 5 to be fastened to the first end 25 of the elongate roller tube 3. In the detailed embodiment, the first 29 and second 31 recesses are disposed on opposing sides of the skirt 27 with a radial spacing of around 180°. As will be evident to the skilled addressee, alternate radial spacings between the recesses could be implemented provided that they serve the purpose of allowing the reducer 5 to be fastened to the first end 25 of the elongate roller tube 3.

The reducer 5 also includes a reducing portion 33 that extends from a first end 35 that is connected to the skirt 27 to a second end 37 that is spaced from the first end 25 of the elongate roller tube 3. The first end 35 of the reducing portion 33 has a larger diameter than the second end 37 of the reducing portion 33. The reducing portion 33 is configured to connect the system to a support structure (e.g. fixed supports disposed on either side of a window) to support the roller blind system in use.

The reducing portion 33 includes first 39 and second 41 mounting apertures formed therethrough that are substantially aligned with the first 29 and second 31 recesses of the skirt 27 respectively. The first and second fasteners 9 are configured to mount the reducer 5 to the roller tube 3. The first fastener, in the form of a self-tapping screw, extends through the first mounting aperture 39 of the reducing portion 33, into the first recess 29 of the skirt 27, and is received between the first 15 and second 17 spaced projections of the first mounting member 11 see FIG. 2). The second fastener, also in the form of a self-tapping screw, extends through the second mounting aperture 41 of the reducing portion 33, into the second recess 31 of the skirt 27, and is received between the first 15 and second 17 spaced projections of the second mounting member 13 (see FIG. 2). As is shown in FIG. 2, the first 11 and second 13 mounting members are disposed on opposite sides of the internal wall of the elongate roller tube 3 such that they are aligned with the recesses 29, 31 of the skirt.

As is shown in FIGS. 1 and 5-7, the system also includes an idler 7 mounted to the reducer 5. As is shown in FIGS. 1 and 7, the idler 7 includes an elongate housing 43 that extends between first 45 and second 47 ends and defines a cavity therein. The idler 7 also includes a face 49 disposed at the first end 45 of the housing 43. The face 49 has an aperture 51 formed therethrough. The idler 7 includes a shaft 53 that extends from the cavity through the aperture 51 and away from the face 49 of the housing 43. The shaft 53 is configured to connect the system to a support structure (e.g. a fixed support) and enable the elongate roller tube 3 to rotate with respect to the support structure in use to move the window covering between the retracted and extended positions. In other words, the shaft 53 that forms part of the idler 7 enables the roller blind system to be rotationally connected to a fixed support structure.

The connection between the reducer 5 and idler 7 will now be described in further detail. The skirt 27 and reducing portion 33 of the reducer 5 together define a mounting aperture 42 that extends through the reducer 5 and along a longitudinal axis A of the reducer 5 (see FIG. 4). The reducer 5 includes an internal wall 44 (see FIGS. 4 and 7) that extends from second end 35 of the reducer and surrounds the mounting aperture 42. The internal wall 44 includes a plurality of spaced slots 46 formed therein that extend substantially parallel to longitudinal axis A of the reducer 5.

The housing 43 of the idler 7 includes a plurality of mounting structures 55 that extend along an outer surface of the housing 43. Each of the plurality of mounting structures 55 is configured to be received by a respective slot 46 of the reducer 5 to mount the idler 7 to the reducer 5.

As is shown in FIG. 7, the internal wall 44 of the reducer 5 includes (terminates at) an annular ledge 57 disposed at a first end 59 of the internal wall 44 and within the housing 27. Each of the plurality of mounting structures 55 of the idler 7 includes a hook 61. The hook 61 each mounting structure 55 and annular ledge 57 cooperate to inhibit movement of the idler 7 with respect to the reducer 5 away from the first end of the roller tube 3 to mount the idler 7 to the reducer 5. In the detailed embodiment, the mounting structures 55 of the idler 7 are tapered to inhibit movement of the idler 7 with respect to the reducer 5 towards the second end (not shown) of the roller tube 3 to mount the idler 7 to the reducer 5.

In the detailed embodiment, both ends of the roller tube 3 include corresponding systems that include the above described structure to support the roller tube 3 at either end. However, as will be evident to the skilled addressee, it may be preferable to include the above described structure at one end of the roller tube 3 and a different support structure at the other end of the roller tube 3 depending on the application.

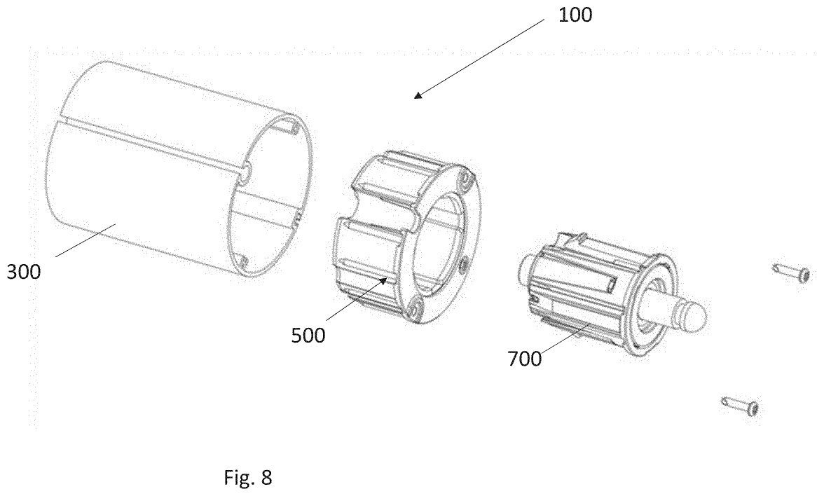

Another embodiment of the system is shown in FIG. 8, which provides a perspective view of the further embodiment. In this embodiment, the system 100 includes the same general components (tube 300. reducer 500 and idler 700. The difference between the system disclosed in FIGS. 1-7 and FIG. 8 is that the reducer 500 that forms part of system 100 does not include the ‘reducing portion’ (i.e. does not facilitate a step down in diameter). Rather, the reducer 500 has a substantially uniform diameter along its length. The idler 700 may have an increased diameter relative to idler 7 as required to correspond with the internal diameter of the reducer 500.

Advantages of the disclosed system may include at least one or more of the following:

The disclosed system may facilitate a relatively simple yet secure connection between the tube, reducer and idler.

The method of securing the reducer to the tube of the disclosed system may not require pre-drilling, may be faster than installing prior art systems, and may require no additional steps relative to prior art systems (e.g. simply fixing the screws to the mounting means of the tube).

The method of securing the reducer of the disclosed system utilises the cut face of the tube and does not require modifying/riveting the diameter face. This may avoid leaving marks on the visual surface of the fabric when the shade is extended (as may be caused by modifying/riveting the diameter face).

The method of securing the idler of the disclosed system may not require any additional tools/fasteners, and may therefore be more time efficient relative to prior art systems.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A system for a window covering, comprising:
an elongate tube around which the window covering is able to be wound, the elongate tube being configured to rotate and thereby move the window covering between a retracted position and an extended position;
first and second mounting members, the first and second mounting members each comprising first and second spaced projections that extend from an internal wall of the elongate tube; and
a reducer mounted to the first end of the elongate tube, the reducer comprising a skirt that is configured to be received within the first end of the elongate tube, the skirt comprising first and second recesses formed therein that are configured to receive the first and second mounting members respectively to enable the reducer to be fastened to the first end of the elongate tube.

2. A system according to claim 1, wherein the reducer comprises a reducing portion that extends from a first end that is connected to the skirt to a second end that is spaced from the first end of the elongate tube, the first end of the second portion having a larger diameter than the second end of the reducing portion, the reducing portion being configured to connect the system to a support structure to support the system in use.

3. A system according to claim 2, wherein the reducing portion comprises first and second mounting apertures formed therethrough that are substantially aligned with the first and second recesses of the skirt respectively.

4. A system according to claim 3, further comprising first and second fasteners configured to mount the reducer to the tube,
the first fastener extending through the first mounting aperture of the reducing portion, into the first recess of the skirt, and being received between the first and second spaced projections of the first mounting member; and
the second fastener extending through the second mounting aperture of the reducing portion, into the second recess of the skirt, and being received between the first and second spaced projections of the second mounting member.

5. A system according to claim 4, wherein the first and second mounting members are disposed on opposite sides of the internal wall of the elongate tube.

6. A system according to claim 1, comprising:
an idler mounted to the reducer, the idler comprising;
an elongate housing that extends between first and second ends and defines a cavity therein;
a face disposed at the first end of the housing, the face having an aperture formed therethrough;
a shaft extending from the cavity through the aperture and away from the face, the shaft being configured to connect the system to a support structure and enable the elongate tube to rotate with respect to the support structure in use to move the window covering between the retracted and extended positions.

7. A system according to claim 6, wherein the skirt and reducing portion of the reducer together define a mounting aperture that extends through the reducer and along a longitudinal axis of the reducer.

8. A system according to claim 7, wherein the reducer comprises an internal wall that extends from second end of the reducer and surrounds the mounting aperture, the internal wall comprising a plurality of spaced slots formed therein that extend substantially parallel to longitudinal axis of the reducer.

9. A system according to claim 8, wherein the housing of the idler comprises a plurality of mounting structures that extend along an outer surface of the housing, wherein each of the plurality of mounting structures is configured to be received by a respective slot of the reducer to mount the idler to the reducer.

10. A system according to claim 9, wherein the internal wall of the reducer comprises an annular ledge disposed at a first end of the internal wall and within the housing, and each of the plurality of mounting structures of the idler comprises a hook, wherein the hook of each mounting structure and annular ledge cooperate to inhibit movement of the idler with respect to the reducer away from the first end of the tube to mount the idler to the reducer.

11. A system according to claim 10, wherein the mounting structures of the idler are tapered to inhibit movement of the idler with respect to the reducer towards the second end of the tube to mount the idler to the reducer.

12. A system according to claim 2, comprising:
an idler mounted to the reducer, the idler comprising;
an elongate housing that extends between first and second ends and defines a cavity therein;
a face disposed at the first end of the housing, the face having an aperture formed therethrough;
a shaft extending from the cavity through the aperture and away from the face, the shaft being configured to connect the system to a support structure and enable the elongate tube to rotate with respect to the support structure in use to move the window covering between the retracted and extended positions.

13. A system according to claim 3, comprising:
an idler mounted to the reducer, the idler comprising;
an elongate housing that extends between first and second ends and defines a cavity therein;
a face disposed at the first end of the housing, the face having an aperture formed therethrough;
a shaft extending from the cavity through the aperture and away from the face, the shaft being configured to connect the system to a support structure and enable the elongate tube to rotate with respect to the support structure in use to move the window covering between the retracted and extended positions.

14. A system according to claim 4, comprising:
an idler mounted to the reducer, the idler comprising;
an elongate housing that extends between first and second ends and defines a cavity therein;
a face disposed at the first end of the housing, the face having an aperture formed therethrough;
a shaft extending from the cavity through the aperture and away from the face, the shaft being configured to connect the system to a support structure and enable the elongate tube to rotate with respect to the support structure in use to move the window covering between the retracted and extended positions.

15. A system according to claim 5, comprising:
an idler mounted to the reducer, the idler comprising;
an elongate housing that extends between first and second ends and defines a cavity therein;
a face disposed at the first end of the housing, the face having an aperture formed therethrough;
a shaft extending from the cavity through the aperture and away from the face, the shaft being configured to connect the system to a support structure and enable the elongate tube to rotate with respect to the support structure in use to move the window covering between the retracted and extended positions.
